(19) United States
(12) Patent Application Publication
(10) Pub. No.: US 2016/0040861 A1
(43) Pub. Date: Feb. 11, 2016

(54) Luminous Object Shaping Structure

(71) Applicant: Chiang-Hsien Tsai, Taipei City (TW)

(72) Inventor: Chiang-Hsien Tsai, Taipei City (TW)

(21) Appl. No.: 14/451,445

(22) Filed: Aug. 5, 2014

(51) Int. Cl. F21V 21/00; F21V 8/00

(52) U.S. Cl. CPC F21V 21/00; G02B 6/001; F21Y 2103/003

(57) ABSTRACT

A luminous object shaping structure helps a user to shape a flexible bar-like luminous object (such as an LED light bar and an optical fiber) into a predetermined configuration. The luminous object shaping structure includes a carrying board and a plurality of pegs and defines a first planar surface and a second planar surface. The carrying board includes through holes extending through the first and planar surfaces. The pegs are mounted to one of the surfaces of the carrying board. The flexible bar-like luminous object is allowed to extend through the through holes and curve and wrap on the pegs in such a way that the luminous object is retained in position by the through holes and the pegs. Thus, a desired shape of for example a character or a figure can be readily formed through one continuous operation of extension and curving of the luminous object.

### TECHNICAL FIELD OF THE INVENTION

The present invention generally relates to a luminous object shaping structure, and more particularly to a structure that assists a user to easily shape a flexible bar-like luminous object into a predetermined configuration.

### DESCRIPTION OF THE PRIOR ART

With the development of science and technology and also due to the severe damage of the ecological environment and the ozone layer of the Earth, most of the countries around the world start to establish and carry out remedial measures. In this respect, one concern is put to the astonishingly great number of lighting devices that are used for daily illumination of people. Further, the traditional lighting devices consume a great amount of electricity, which in turn generates a great amount of carbon. Thus, currently, LED (Light-Emitting Diode) light devices, which save energy and electricity and have high efficiencies and extended service lives, have been widely used in every country to replace the traditional lighting devices.

A luminous object, such as an LED light bar and an optic fiber, besides the function of lighting and illumination, can be made various shapes of predetermined characters and figures for the purposes of decoration, aesthetics, and commercial advertisement.

However, heretofore, luminous objects are made to form specific shapes and users are not allowed to handle the luminous objects to form different shapes of characters and figures. Taking flexible bar-like luminous objects, such as an LED light bar and an optic fiber, as an example, to form various shapes of characters and figures, multiple sections of luminous objects musts be properly arranged and these shapes of characters and figures cannot be readily formed through a continuous operation of penetration and curving of the luminous objects. Thus, it is desired to provide an assisting fixture that helps shape a flexible bar-like luminous object to form a predetermined configuration.

Thus, the present invention aims to provide a solution to handle the above problems.

### SUMMARY OF THE INVENTION

An object of the present invention is to provide a structure that allows a flexible bar-like object to extend through holes and curve about pegs in such a way that the holes and the pegs hold the luminous object in position so that a predetermined shape of the luminous object can be readily formed through a continuous extension and curving operation.

To achieve the above object, the present invention provides a fixture that helps shape a flexible bar-like luminous object into a predetermined configuration and comprises a carrying board and a plurality of pegs, wherein the carrying board defines a first planar surface and a second planar surface. The carrying board comprises a plurality of through holes extending through the first planar surface and the second planar surface to receive extension of the luminous object therethrough. The pegs are mounted to one of the first planar surface and the second planar surface of the carrying board to provide supports for the luminous object curving and wrapping thereon.

The flexible bar-like luminous object is set to extend through the through holes and curving and wrapping on the pegs in such a way that the luminous object is held in position by the through holes and the pegs. Thus, a desired shape of a character or a figure can be readily formed through one continuous operation of extension and curving of the luminous object without the need to joint multiple sections of luminous objects and users are allowed to handle such an operation by themselves, allowing shaping to be readily done.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a top side of the present invention.

FIG. 2 is a perspective view showing a bottom side of the present invention.

FIG. 3 is a schematic view showing an application of the present invention.

FIG. 4 is a schematic view showing a back side of application of the present invention to illustrate assembling thereof

FIG. 5 is a perspective view showing a structure and us of an insertable pin of the present invention.

FIG. 6 is a schematic view showing an application of the present invention comprising the insertable pin.

FIG. 7 is a schematic view showing an application of the present invention to illustrate coupling between carrying boards.

FIG. 8 is a perspective view showing a top side of the carrying board of the present invention comprising pegs mounted thereon.

FIG. 9 is a schematic view showing an application of FIG. 8.

FIG. 10 is a perspective view showing a connection plate connecting between insertable pins of the present invention.

FIG. 11 is a schematic view showing an application of FIG. 10.

FIG. 12 is a perspective view showing a connection plate connecting between pegs of the present invention.

FIG. 13 is a schematic view showing an application of FIG. 12.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

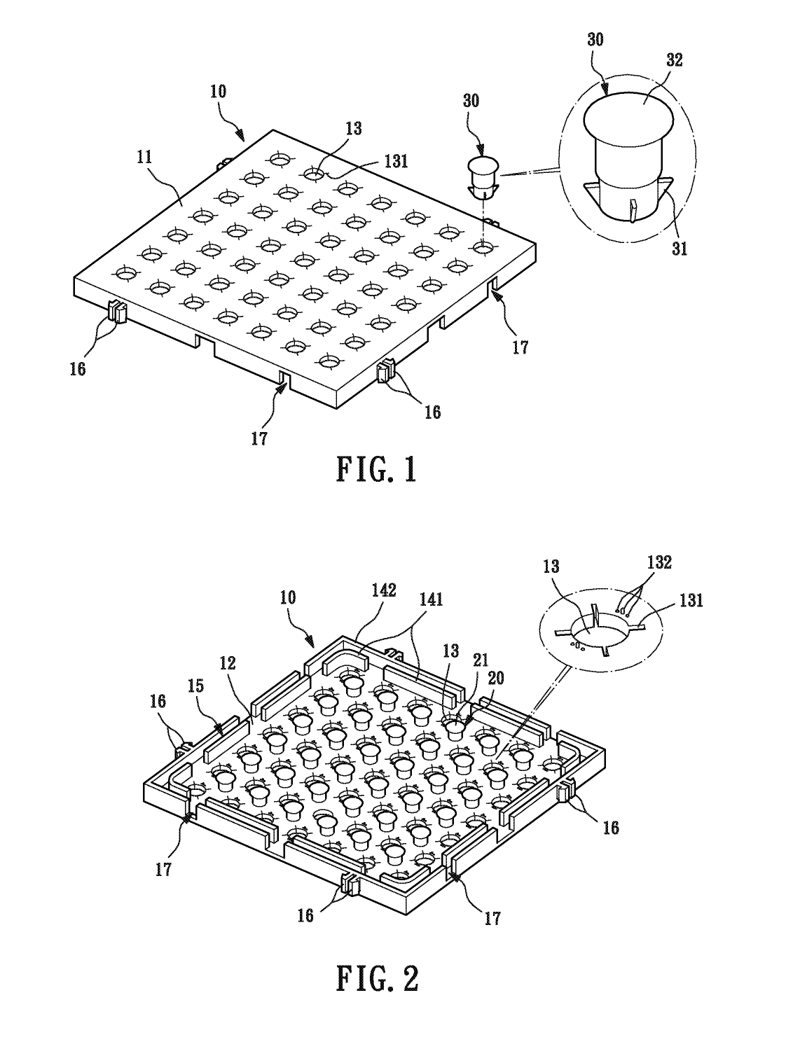

Referring to FIGS. 1, 2, and 3, the present invention is provided for helping a user to shape a flexible bar-like luminous object 90 (such as an LED light bar and an optic fiber) into a predetermined configuration. In a preferred embodiment, the present invention comprises a carrying board 10 and a plurality of pegs 20, of which details will be described hereinafter.

The carrying board 10 has a predetermined size and has upper and bottom sides that respectively define a first planar surface 11 and a second planar surface 12. The carrying board 10 comprises a plurality of through holes 13 extending through the first planar surface 11 and the second planar surface 12 to receive extension of the luminous object 90 therethrough. The second planar surface 12 comprises a plurality of internal walls 141 and a plurality of external walls 142 formed thereon. The internal walls 141 and the external walls 142 collectively define a plurality of retention channels 15.

The pegs 20 are mounted to the second planar surface 12 of the carrying board 10 to serve as supports about which the luminous object 90 is curved. The pegs 20 each have a free end forming an expanded stop portion 21.

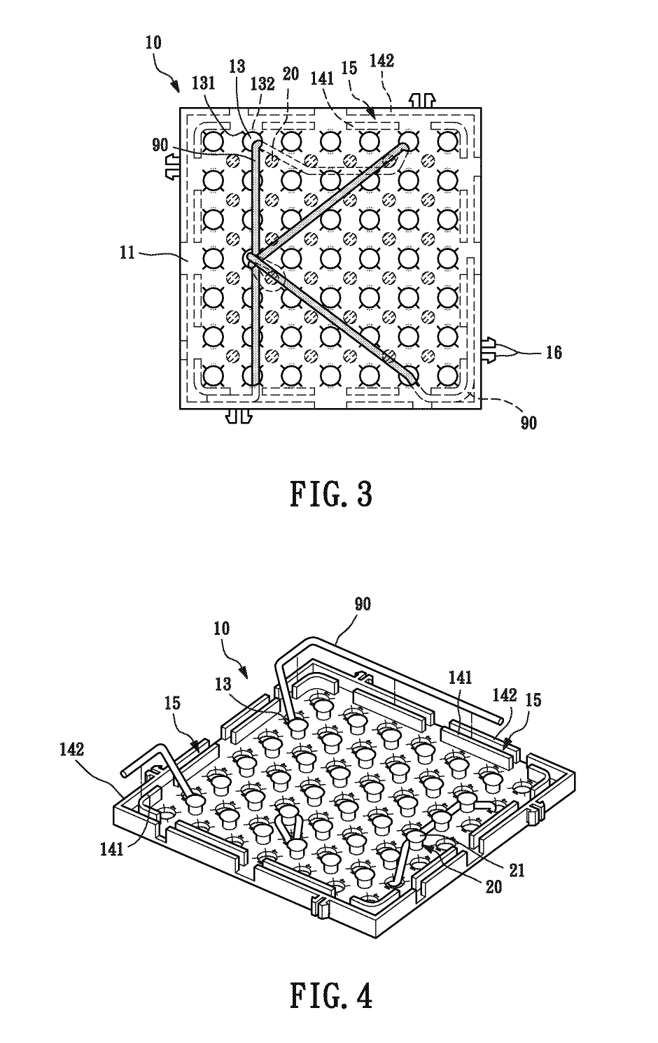

Referring to FIGS. 3 and 4, to use the present invention, the flexible bar-like luminous object 90 is set to extend through predetermined ones of the through holes 13 and curving and wrapping about the pegs 20 in such a way that the luminous object 90 is held in position by the through holes 13 and the pegs 20. Thus, a desired shape of for example a character or a figure can be readily formed on the first planar surface 11 of the carrying board 10 through one continuous operation of extension and curving of the luminous object 90 without the need to joint multiple sections of luminous objects and users are allowed to handle such an operation by themselves, allowing shaping to be readily done.

Two ends of the luminous object 90 can be set and retained in the retention channels 15 defined collectively by the internal walls 141 and the external walls 142 to achieve an effect of concealing and finishing.

The portions of the luminous object 90 that are curved and wrapped around the pegs 20 are constrained by the stop portion 21 of the pegs 20 so as not to slide off.

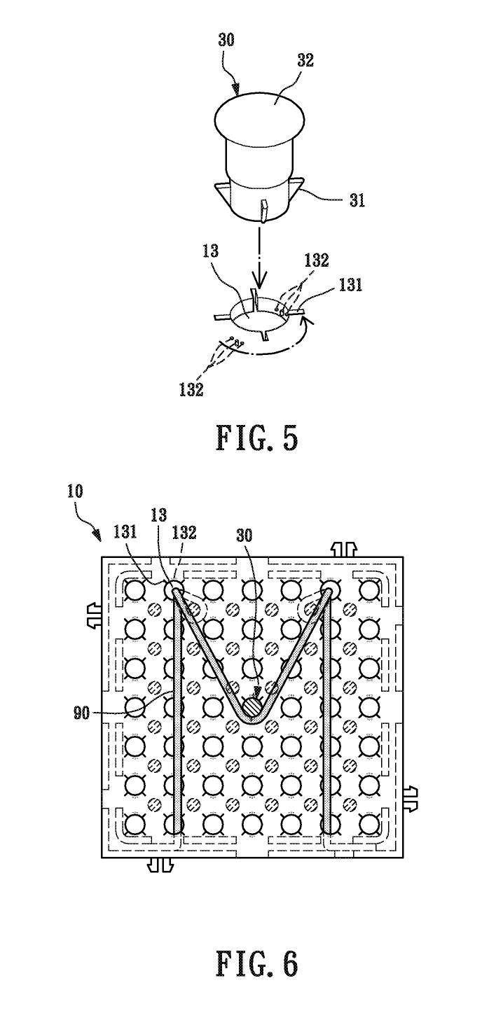

Referring to FIGS. 1, 2, 5, and 6, in an embodiment of the present invention, the through holes 13 of the carrying board 10 are selectively coupled to at least one insertable pin 30. The through holes 13 each have a circumferential wall in which a plurality of through slots 131 is defined. The second planar surface 12 is provided with a plurality of raised beads 132 adjacent to each of the through holes 13. The insertable pin 30 has a circumferential surface on which a plurality of projections 31 is formed to respectively correspond to the through slots 131. The insertable pin 30 has an end forming an expanded stop portion 32.

The insertable pin 30 can be operated by having the projections 31 penetrating through the through slots 131 and the insertable pin 30 is rotated to have the projections 31 engaging and retained in position by the raised beads 132, whereby the insertable pin 30 is securely fixed to the through hole 13 of the first planar surface 11 of the carrying board 10 to allow the luminous object 90 to be curved thereon and to be constrained thereby so as to enhance the variability and complication of the shaped configuration of the luminous object 90.

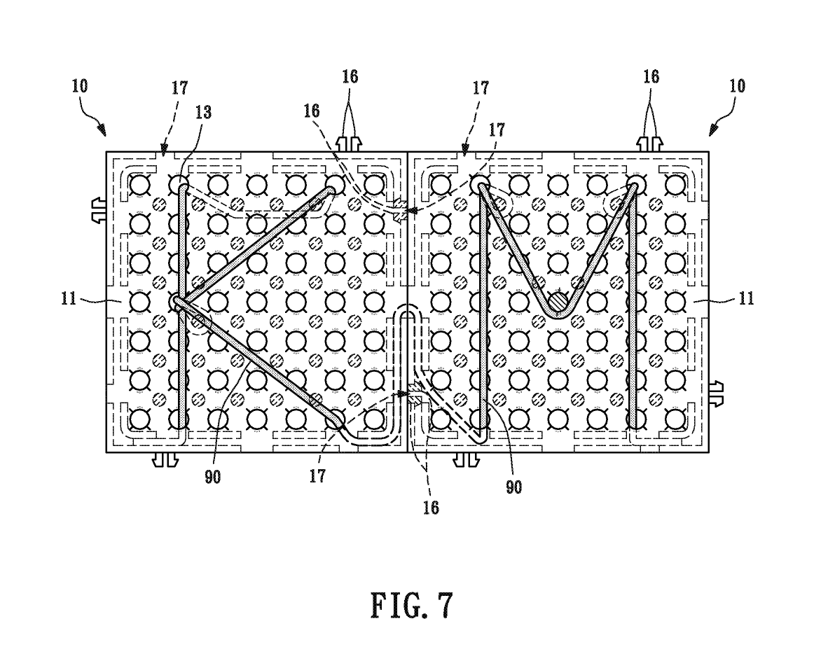

Referring to FIGS. 1, 2, and 7, in an embodiment of the present invention, the carrying board 10 has a circumferential surface on which a plurality of coupling portions 16 and a plurality of counterpart portions 17 are formed. The coupling portions 16 and the mating portions 17 correspond to and are engageable with each other so that the coupling portions 16 of the carrying board can mate and be coupled to the mating portions 17 of an additional carrying board 10. The coupling portions 16 can be elastic pawls to achieve an engaging and coupling effect.

As such, multiple carrying boards 10 can be coupled together to receive a luminous object 90 to extend and curve thereon for expansion of the carrying area for the shaped configuration of the luminous object 90 and to achieve an increase of the number of the shaped configurations that the luminous object 90 can be formed.

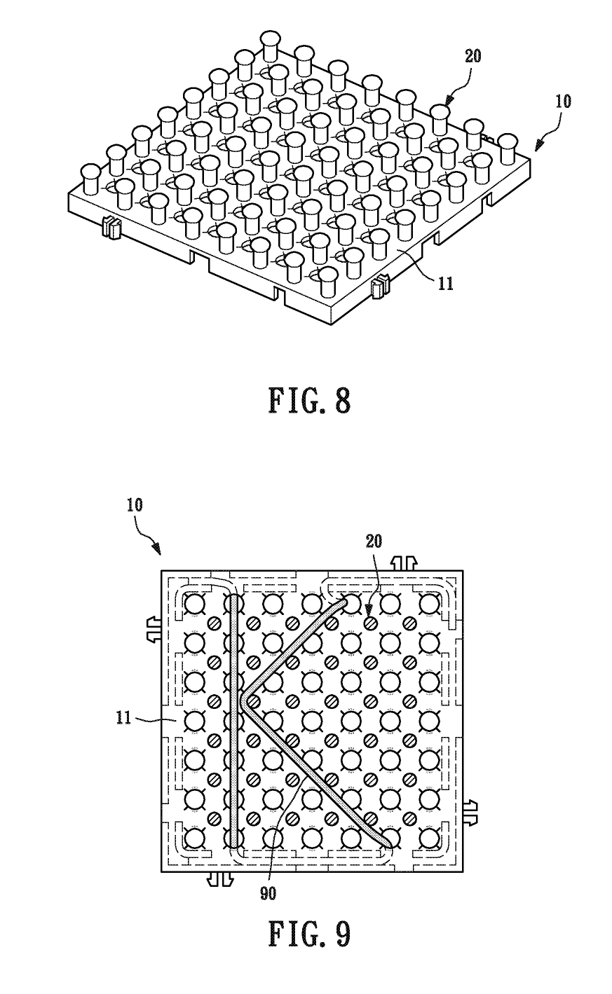

Referring to FIGS. 8 and 9, in an embodiment of the present invention, the first planar surface 11 of the carrying board 10 may be additionally provided with a plurality of pegs 20 so as to allow the luminous object 90 to be curved and wrapped thereon and to be constrained thereby enhancing the variability and complication of the shaped configuration of the luminous object 90 with more dedicate and aesthetic details of the configurations.

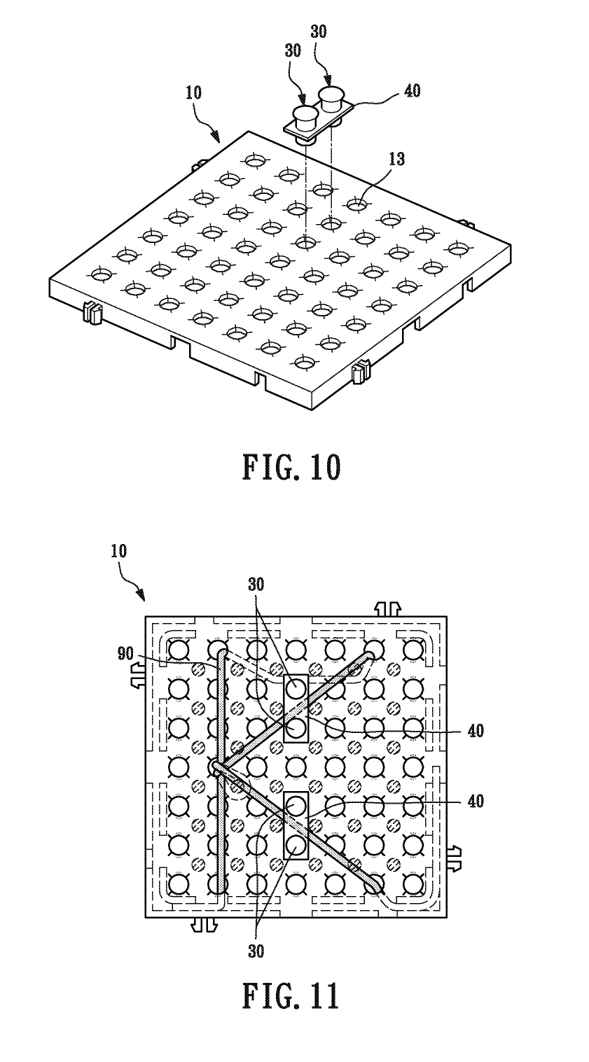

Referring to FIGS. 10 and 11, in an embodiment of the present invention, a connection plate 40 is provided to joint between insertable pins 30. The connection plate 40 can be used to hold and fix the portion of the luminous object 90 extending between the insertable pins 30 in order to fix the shaped configuration of the luminous object 90.

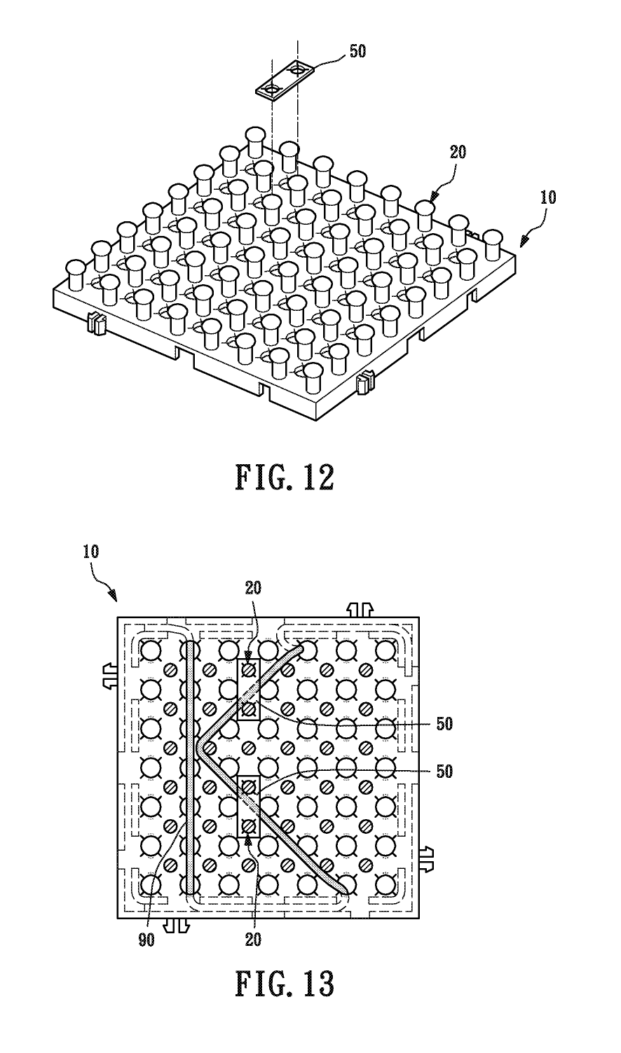

Referring to FIGS. 12 and 13, in an embodiment of the present invention, a connection plate 50 is provided to joint between the pegs 20 of the carrying board 10. The connection plate 50 can be used to hold and fix the portion of the luminous object 90 extending between the pegs 30 in order to fix the shaped configuration of the luminous object 90.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A luminous object shaping structure, which serves as a fixture that helps shape a flexible luminous object into a predetermined configuration, the luminous object shaping structure comprising:
a carrying board, which defines a first planar surface and a second planar surface, the carrying board comprising a plurality of through holes extending through the first planar surface and the second planar surface to receive extension of the luminous object therethrough; and
at least one peg, which is separate from the luminous object and is mounted to one of the first planar surface and the second planar surface of the carrying board to allow the luminous object to selectively curve and wrap around outside the peg by having the luminous object partly folded around the peg;
wherein a connection plate that is separate from the carrying board is connected between two pegs so that the connection plate holds and fixes a portion of the luminous object extending between the two pegs by having the portion of the luminous object sandwiched between the connection plate and the carrying board.

2. The luminous object shaping structure according to claim 1, wherein the second planar surface comprises a plurality of internal walls and a plurality of external walls formed thereon, the internal walls and the external walls collectively defining a plurality of retention channels.

3. The luminous object shaping structure according to claim 1, wherein the pegs each have an end forming an expanded stop portion that is distant from the carrying board to allow the luminous object wrap around the peg and held between the expanded stop portion of the peg and the carrying board.

4. The luminous object shaping structure according to claim 1, wherein the through holes of the carrying board are coupled to at least one insertable pin, the through holes each having a circumferential wall in which a plurality of through slots is defined, the carrying board comprising a plurality of raised beads formed thereon to be adjacent to each of the through holes, the insertable pin having a circumferential surface on which a plurality of projections is formed and extends radially from the circumferential surface to respectively correspond to the through slots, whereby the insertable pin is operable to have the projections penetrating through the through slots and the insertable pin is rotated to have the projections engaging and retained in position by the raised beads and the projections being set in engagement with a surface of the carrying board to be attached to the carrying board.

5. The luminous object shaping structure according to claim 4, wherein the insertable pin has an end forming an expanded stop portion that is distant from the carrying board to allow the luminous object wrap around the insertable pin and held between the expanded stop portion of the peg and the carrying board.

6. The luminous object shaping structure according to claim 4, wherein a connection plate is connected between insertable pins so that the connection plate holds and fixes a portion of the luminous object extending between the insertable pins by having the portion of the luminous object sandwiched between the connection plate and the carrying board.

7. The luminous object shaping structure according to claim 1, wherein the carrying board has a circumferential surface on which a plurality of coupling portions and a plurality of counterpart portions are formed, the coupling portions and the mating portions corresponding to and engageable with each other, whereby the coupling portions are engageable with and coupled to mating portions of an additional carrying board.

8. The luminous object shaping structure according to claim 7, wherein the coupling portions are elastic pawls.

9. (canceled)
